(19) United States
(12) Patent Application Publication
(10) Pub. No.: US 2006/0156929 A1
(43) Pub. Date: Jul. 20, 2006

(54) Wine punch down unit

(76) Inventors: Ned Nelson, Bellevue, WA (US); Ross Mickel, Bellevue, WA (US)

Correspondence Address: David L. Garrison;Suite 3300, 2001 Sixth Avenue, Seattle, WA, 98121-2522, US

(21) Appl. No.: 11/336,112

(22) Filed: Jan. 20, 2006

Related U.S. Application Data
(60) Provisional application No. 60/645,911, filed on Jan. 20, 2005.

(51) Int. Cl. A21B 7/00

(52) U.S. Cl. 99/348

(57) ABSTRACT

A wine punch down unit and method for processing fermenting wine by punching down a cap formed from buoyant skins, seeds, pulp, and stems within a batch of fermenting wine, and mixing the cap material with the fermenting wine to improve contact between the wine and the cap in order to extract a requisite amount of color and flavor. The wine punch down unit has a platform for placement under a vessel of fermenting wine, a vertical shaft mounted to the platform supporting a positionable arm that holds a vertically extendible agitator accessory. The agitator accessory is operational in an upward and downward and side-to-side manner for punching down the cap and mixing the cap material with the fermenting wine. This invention further relates to a vertical shaft adaptor as used by a wine maker for adapting a pallet jack or similar lift platform to securely hold a vertical shaft for supporting a device such as a wine punch down unit.

### CROSS-REFERENCE TO RELATED APPLICATION

This application claims priority to U.S. Provisional Patent Application No. 60/645,911, entitled “WINE PUNCH DOWN UNIT,” filed Jan. 20, 2005.

### TECHNICAL FIELD

This invention relates generally to a juice processing equipment as used for making wine from grapes, fruit, or like material. Particularly, this invention relates to a wine punch down unit and method for processing juice or fermenting wine by punching down a cap formed from buoyant skins, seeds, pulp, and stems within a batch of fermenting wine, and mixing the cap material with the fermenting wine to improve contact between the wine and the cap in order to extract a requisite amount of color and flavor. This invention further relates to a vertical column adapter as used by a wine maker for adapting a pallet jack or similar platform to securely hold a vertical column for supporting a device such as a wine punch down unit.

### BACKGROUND OF THE INVENTION

Wine is typically made by crushing and de-stemming grapes and then extracting color and flavor components from the grape skins and pulp by allowing the crushed grapes, including their juice, to sit for a period of time referred to as an extraction period. This extraction period is followed by or is part of a fermentation stage where yeast introduced to the mixture converts the sugars in the grape juice to alcohol and carbon dioxide. The fermentation can also facilitate in extracting flavor and color from the skins. This process is often referred to as “maceration.” The liquid or partially fermented grape juice, referred to as “must”, is typically pressed from the skins, stems, and other solids, collectively referred to as “pomace,” and transferred to a secondary vessel for further processing.

During the extraction period the large solids typically float to the surface of the crushed grapes to form a “cap.” This cap can be relatively thick and dense, and portions can partially dry out, which diminishes extraction. If fermentation is occurring, the carbon dioxide formed by the yeast can also carry solids to the surface because the gas bubbles nucleate on the solids and carry them to the top of the liquid.

In order to improve the extraction of flavor and color, the cap can kept moist by a number of techniques, including manual methods, used by the winemaker to push portions of the cap into the must. Once fermentation begins, the cap must be periodically mixed with the liquid mixture, punched down or pumped over. Extraction of the requisite amount of red color from the skins will not be obtained unless there is contact between fluid and the cap. For example, it may be desirable to punch the cap down twice a day. In smaller batches, this can be done by hand. In larger tanks, a rake or other instrument is used for punching down. A pump may be used in a pump over to draw off fermenting fluid below the cap and distributed over the cap.

The thickness and density of the cap often requires the application of considerable downward force to sufficiently break up the cap for mixing. Each time the cap is to be punched down, a repeated forceful punching down procedure is typically required which, if performed manually, can be extremely labor intensive. Mechanical and automated means for punching a wine cap have become preferred as shown in the development of the prior art.

U.S. Pat. No. 3,604,690 teaches an agitation device for vessels such as fermenters containing a liquid. The agitation device has at least one rotatable disc with a serrated perimeter, an axial impeller concentric with the disc and at least one baffle cooperable with the serrated edge of the disc, arranged to generate zones of shear in the liquid as the disc rotates.

U.S. Pat. No. 4,474,890 teaches a horizontal tank-type wine fermentation container equipped with a rotating agitator for processing wine grape must. A pomace cap floating on the surface of the must is disintegrated and punched down into the body of the must by means of the disclosed flat wide blade sections of the rotating agitator.

U.S. Pat. No. 4,799,862 teaches a rotating impeller for stirring liquids contained in tanks and a mixing apparatus having tanks fitted with such impellers. Particularly, this invention teaches various embodiments of curved impeller blades to produce improved power, decreased mixing time, and energy consumption efficiency.

U.S. Pat. No. 6,703,055 teaches a device and process for wine fermentation cap management and pomace removal. The device has a tank with at least one impeller, each impeller having a plurality of blades to radially and axially move the cap during fermentation and to blend the cap with liquid to permit draining of the cap (or pomace) through a drain in the tank. The radial and axial movement of the cap is by the fluid force generated by rotating impeller.

The above-mentioned prior art references particularly address processes and devices for improved agitation of a cap within fermenting liquid. While advances in processes and devices for production of wine have proven beneficial, particularly to producers of wine in large quantities, there has been a resulting increase in the complexity and cost of such devices. There remains a need for a simplified and economical method and apparatus for mixing a cap within fermenting liquid, particularly when smaller batches are being processed.

Smaller wine producers may be compelled to seek more economically feasible means of performing wine-making steps, including the punching down and mixing of a cap within a batch of fermenting liquid. Common pallet jacks, as are well known in the art of load lift vehicles, are commonly utilized for a variety of purposes by the small and large wine producers alike. One typical use is the lifting and transport of vessels containing grapes and juice for processing. An added benefit of the pallet jack would result if it could be converted to simplify and make more economical the wine production process.

U.S. Pat. No. 6,732,871 discloses an apparatus for handling cargo that includes a motorized electric pallet truck to which a tower is attached with a mechanical arm attached to the tower and at least one pneumatically operated device attached to the arm having lifting capability. This invention teaches an apparatus that could be used for lifting activities as might be required in the wine making industry, but does not address the needs for a simplified way of adapting a wine punch down unit to a pallet truck, either for temporary or permanent use.

Therefor, a need exists for an adapter for a palletjack or similar platform in order to support a wine punch down unit on a vertical column for temporary or permanent use.

### OBJECTS OF THE INVENTION

In view of the foregoing, it is an important object of the present invention to provide a simplified and economical apparatus and method for mixing a cap within fermenting wine, thereby improving contact between the wine and the cap.

It is another object of the present invention to provide a vertical column adapter for use by a wine maker for adapting a pallet jack or similar platform to securely hold a vertical column for supporting a device such as a wine punch down unit.

A further object of the present invention is to provide a releasable vertical column adapter for use by a wine maker for temporarily or permanently adapting a pallet jack or similar platform to securely hold a vertical column for supporting a device such as a wine punch down unit.

### DISCLOSURE OF THE INVENTION

The present invention is directed to a wine punch down unit and method for processing wine by punching down a cap formed from buoyant skins, seeds, pulp, and stems within a batch of wine, and mixing the cap material with the juice being processed to improve contact between the wine and the cap in order to extract a requisite amount of color and flavor. The wine punch down unit has a platform for placement under a vessel of juice, a vertical shaft mounted to the platform supporting a positionable arm that holds a downwardly extendible agitator accessory. The agitator accessory is operational in an upward and downward and side-to-side manner for punching down the cap and mixing the cap material with the juice. This invention further relates to a vertical column adaptor as used by a wine maker for adapting a pallet jack or similar lift platform to securely hold a wine punch down unit on a vertical column for temporary or permanent use.

### BRIEF DESCRIPTION OF THE DRAWINGS

FIG. 1 is a perspective view of a wine punch down unit of the present invention.

FIG. 2 is a side elevation of a wine punch down unit as shown in FIG. 1.

FIG. 3 is a plan view as seen from above of a wine punch down unit as shown in FIG. 1.

FIG. 4 is a perspective view of a preferred embodiment for a vertical column adapter of the present invention mounted on a common pallet jack.

FIG. 5 is a perspective view of a bracket for mounting the vertical column adapter as shown in FIG. 4 on a common pallet jack.

FIG. 6 is a partial end sectional view of the vertical column adapter as shown in FIG. 4.

FIG. 7 is a cross-sectional view of the vertical column adapter as shown in FIG. 4 as seen from the front.

FIG. 8 is a side sectional view of the vertical column adapter as shown in FIG. 4.

FIG. 9 is a side elevation of a wine punch down unit as shown in FIG. 2 illustrating one phase of operation.

FIG. 10 is a side elevation of a wine punch down unit as shown in FIG. 2 illustrating a second phase of operation.

### DETAILED DESCRIPTION OF THE INVENTION

For a complete understanding of the features and operation of the present invention, reference is now made to the drawings of the invention along with the accompanying figures in which corresponding numerals in the different figures refer to corresponding parts of the invention.

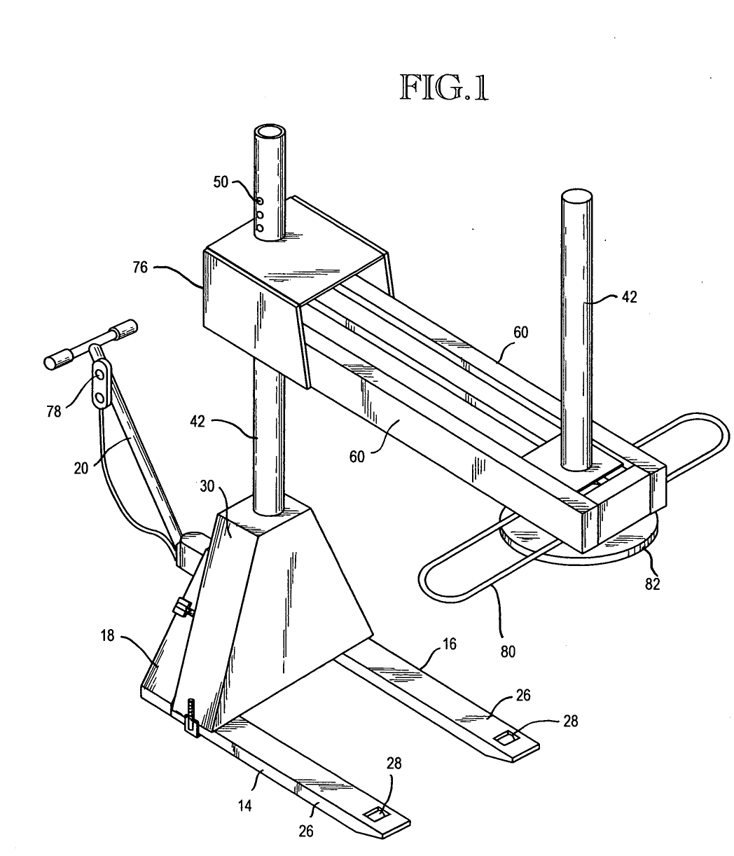

The general features of a preferred embodiment of a wine punch down unit 2 for processing fermenting wine in accordance with the present invention is shown in the perspective view in FIG. 1. A fermentation vessel 4 used in the processing of wine is an open-top box vat. Crushed grapes, including their juice, skins, seeds, stems and pulp (collectively the pomace), are introduced into the vessel through the open top in preparation for an extraction period, during which color and flavor is extracted from the solids by the juice (the must). Yeast is added to the combination of pomace and must if fermentation is to be part of this extraction period, or maceration. The pomace and must combination remain in the vat for the duration of maceration and for further processing.

A cap 8 of thick, dense pomace that forms at the top of the fermenting wine 6 must be periodically punched down with the punch down unit in order to keep the cap 8 moist for mixing the cap material with the fermenting wine 6 to improve contact between the wine for extraction of a requisite amount of color and flavor.

The punch down unit 2 is preferably mounted to a movable pallet truck such as a common pallet jack 14, which essentially provides a ground engaging platform that supports the fermentation vessel 4 and the punch down unit 2. Generally, a vertical column is affixed to the operator end of the pallet jack, and supports a rigid arm that in turn supports a powered ram. Attached to the operational end of a shaft extending downward is an agitator paddle. In operation, the powered ram is positioned above the fermentation vessel to allow the agitator paddle to be forcefully extended downward through the cap formed on the fermenting wine therein.

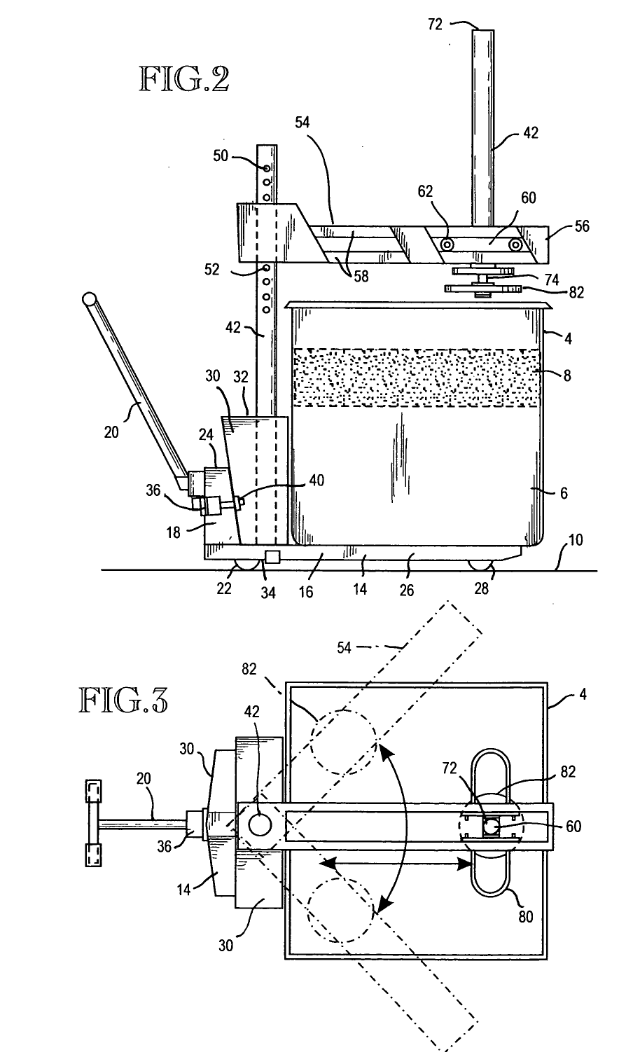

FIG. 2 and FIG. 3 show a side elevation and a plan view, respectively, of the wine punch down unit shown in FIG. 1. Shown is a common pallet jack 14 having a base 16, a hydraulic jack 18 engaging the base 16 to provide lift to the base, a steerable jack handle 20 engaging the hydraulic jack 18 that controls the lifting and lowering of the hydraulic jack 18. The steerable jack handle 20 operably communicates with a pair of steering casters 22 that engage the ground 10 and support the hydraulic jack 18 to which it is connected. The hydraulic jack 18 operably engages the pallet jack base 16 which has a base frame 24 connecting a pair of parallel fork rails 26 that operate in unison to lift a fermentation vessel 4. Each of the fork rails 26 has a movable load caster 28 rotatably engaged with the underside of each fork rail and located along the fork rail at the opposite end from the pallet jack base 16.

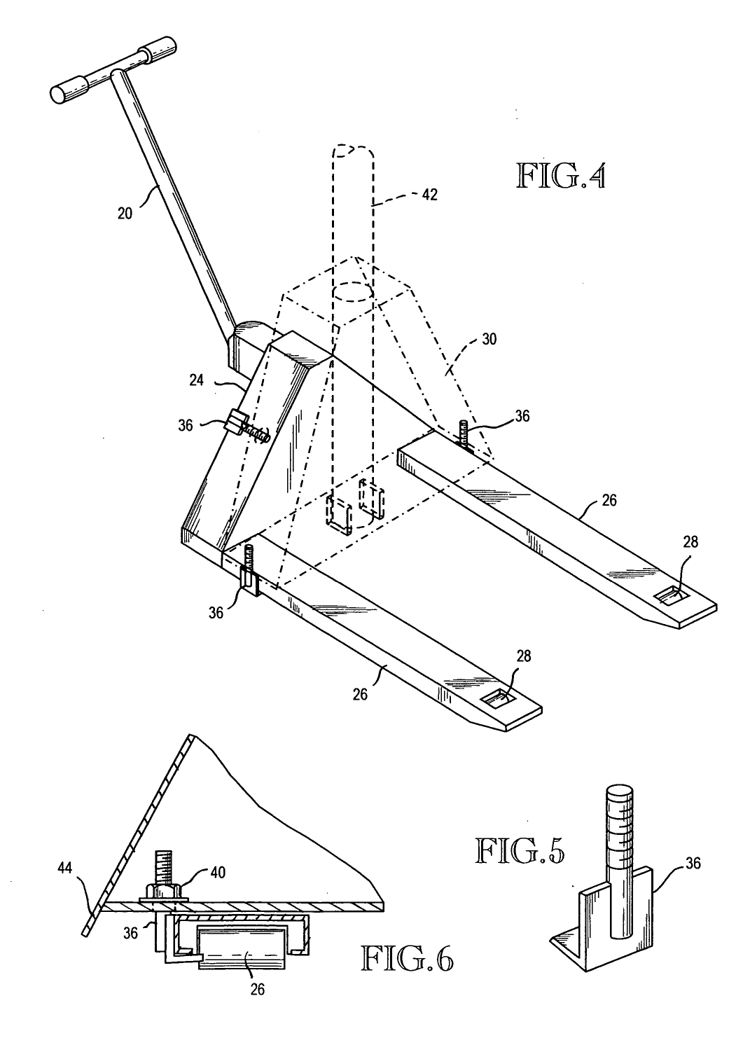

A vertical column adapter 30 is shown in FIG. 4, 7 and 8 having an essentially pyramid-shaped frame 32 with a top, a base, a front, a back and two side extensions 34. The column adapter frame 32 is secured to the pallet jack base frame 24 using four threaded adapter mounting brackets 36, a typical bracket shown in FIG. 5 having integral angle plates the threaded portions extending through slotted apertures 38 in the front of the adapter frame 32 and grabbing onto a perimeter section of the pallet jack base frame 24 as shown in FIG. 2, and in the base of the adapter frame 32, which when nuts 40 are tightened onto the threaded portions of the brackets 36, secures the adapter frame 32 to each of the pallet jack fork rails 26 as shown in FIG. 6. Each of the two sides extensions 34 extends below a horizontal plane established by the base, and are angled downward and outward from the top to the base. While attached to a pallet jack 14 , the side extensions 34 are in close proximity to the ground 10, and will engage the ground with any significant lateral rotation of the pallet jack, thus providing a safeguard against tipping of the pallet jack 14, fermentation vessel 4, and wine punch down unit 2.

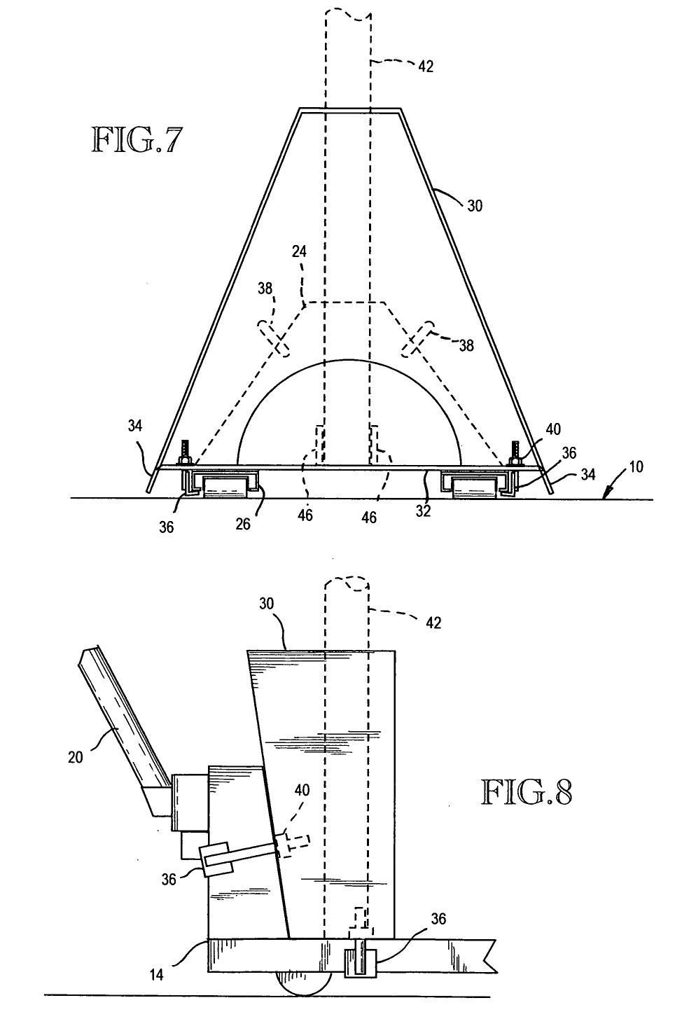

A cylindrical vertical column 42 is secured to the vertical column adapter 30 as shown in FIGS. 4 and 7 by circular aperture in the top of the adapter 30 having a diameter that accepts the diameter of the column 42, thus allowing the column to be laterally supported by the snug fit of the column adapter 30, and further secured with a column mounting bolt 44 or pin projecting through aligned apertures in the bottom of the column 42 and in a mounting bracket formed by a pair of vertically arranged column mounting tabs 46 on the inside base of the column adapter frame 32. An access aperture on the back of the vertical column adapter 30 allows access to the column mounting tabs 46 and the base mounting brackets 36. The vertical column 42 has a series of regularly spaced, horizontally aligned apertures 50 along its upper length for receiving a vertical adjustment pin 52 as shown in FIG. 2.

A rigid arm 54 extends horizontally and is rotatably engaged with the vertical column 42 at one end of the arm as shown in FIGS. 2 and 3. A circular aperture in one end of the arm 54 has a diameter that accepts the diameter of the column 42 such that the arm is freely rotatable on a horizontal plane about the column as shown in FIG. 3. The vertical adjustment pin 52 can be removed and repositioned to any other pair of the apertures 50 in order to set the height of the arm 54 on the column 42. The arm 54 has a body 56 with two parallel sides, each side being of a box beam construction in order to provide strength and rigidity to the arm 54. The arm 54 is preferable made of metal, such as a light-weight, high strength aluminum. The two sides are attached to each other at opposing ends of the arm to provide an open channel along the length of the arm 54 between the column 42 and the end furthest from the column. Two spaced parallel rails 58 are affixed to an inside wall of each side extending along the axis of the arm 54 and providing track within the channel.

FIGS. 2 and 3 show an agitator support frame 60 having a rigid box-like structure having two sides with two rollers 62 on each side rotatably engaging the support frame 60 and communicating with the rails 58 on each inside wall of the rigid arm 54. The spacing of the rails 58 accommodates the diameter of the rollers 62 and allows free travel of the rollers and support frame 60 along the axis of the rails 58 while limiting travel in an upward and downward direction. Preferably, pneumatic powered ram 72 is affixed to the support frame 60 on a vertical axis, the powered ram 72 having a shaft 74 that is extendible in a downward direction and is retractable in an upward direction. The powered ram 72 is controlled by a power control unit 76 mounted to the rigid arm body 56 at the first end of the rigid arm 54, and contains electronic and hydraulic control circuitry as is well known in the art of electronic and hydraulic controls for powered rams. Associated control cabling and/or hydraulic hoses extend from the powered ram to the control unit. A hand control 78 on a pendant cable interfaces the control unit and allows an operator of the wine punch down unit to control the operation of the powered ram 72 from any location around the perimeter of the fermentation vessel 4.

A tubular handle assembly 80 as shown in FIG. 3 is affixed to the support frame 60 providing a U-shaped handle on each side of the rigid arm 54. The handles 80 allow an operator of the wine punch down 2 unit to manually position the support frame 60 with its associated powered ram 72 and an agitator accessory horizontally along the length of the rigid arm 54 between the vertical column 42 and the end furthest from the column, and to manually position the rigid arm 54 through an arc of rotation about the vertical column 42.

In this preferred embodiment, the agitator accessory is an agitator paddle 82 having a flat rectangular plate-like structure is affixed to the end of the powered ram vertical shaft 74 and is mounted on a plane perpendicular to the axis of the vertical shaft 74. The vertical shaft 74 is of a length that provides extension of the agitator paddle 82 downward into and near the bottom of a fermentation vessel 4. The agitator paddle 82 is of sufficient strength and rigidity to withstand the forces imposed by the downward extending powered ram 72 and a thick dense cap 8 within the fermentation vessel 4.

The wine punch down unit 2 is operated by positioning the pallet jack 14 under a filled fermentation vessel 4, and lifting the fermentation vessel 4 slightly off the ground 10 with the pallet jack 14. The weight of the filled fermentation vessel 4 acts on the pallet jack 14 platform to stabilize and make rigid the vertical column 42 with respect to the fermentation vessel 4. An operator then adjusts the height of the rigid arm 54 with respect to the vertical column 42 in order to assure clearance of the agitator paddle 82 and the top of the fermentation vessel 4 when the vertical shaft 74 of the powered ram 72 is in its extreme upward position. The operator then uses the handle assembly 80 to position the rigid arm 54 and agitator paddle 82 over the fermentation vessel 4. Next, the operator uses the hand control 78 to actuate the power control unit 76 to extend downward and retract upward the agitator paddle 82 in a reciprocating motion to punch down the cap 8, breaking it up and mixing the cap material with the fermenting wine 6 as shown in FIGS. 9 and 10. The operator repositions the agitator paddle 82 to any desired position over the fermentation vessel 4 as shown in FIG. 3 using the handle 80 to rotate the rigid arm 54 or to move the agitator paddle 82 along the arm rails 58. The punch down process is then repeated until a desired agitation of the cap 8 and fermenting wine 6 is achieved.

The punch down process typically requires a substantial amount of downward force to break through the cap, hence the preferred embodiment of a pneumatic ram. It will be obvious to those skilled in the art of wine making equipment to use a hydraulic ram, a motorized agitation device, or some combination of other manual or mechanical means. Alternate embodiments of the present invention may include an agitation accessory that rotates or provides a combination of rotational and vertical agitation as by attachment of the agitation accessory to a motor mounted rotating shaft that is also acted upon by a powered ram. The agitation accessory itself can be of any possible size, shape, or configuration that will allow breaking up of a cap such as cone-shaped devices, ball-shaped devices, impeller devices, or any combination of these devices.

The wine punch down unit embodiment described above uses manual means to position the agitation accessory along the rigid arm, and to position the rigid arm with respect to the column. It will be obvious to alternatively use a motorized means or combination of manual and motorized means to allow positioning such as with controllable electric motors, automated motorized positioning, or other mechanical combinations. It will also be obvious to use any number of means for positioning the rigid arm with respect to the column. A motorized cable or gear drive system could be used to raise and lower the rigid arm. Alternatively, a pneumatic or hydraulic ram, internal or external to the column, could be used for vertical positioning of the rigid arm. Also, a simple rack and pinion could be used to allow manual height adjustment and to maintain the rigid arm at the desired height on the vertical column.

The preferred embodiment makes use of a pallet jack adapted to securely hold a vertical column of a wine punch down unit. Alternative embodiments of a wine punch down unit include any possible ground engaging platforms that securely hold the vertical column, such as a platform integral with the wine punch down unit for placement under a fermentation vessel. A positionable arm mounted to a fixed wall or ground support are other obvious alternatives.

The vertical column adapter of the preferred embodiment of the present invention could have other applications in addition to supporting the vertical column of a wine punch down unit. A pallet jack or other ground engaging platforms could be adapted with the vertical column adapter in any industry for temporary or permanent conversion of the pallet jack to support vertically mounted lifting equipment such as an engine lift or overhead pallet lift.

### INDUSTRIAL APPLICABILITY

The present invention has applicability to the field of juice processing equipment for use in making wine from grapes, fruit, or like material. This invention further has applicability to other fields of mechanical equipment as related to a vertical column adapter adapting a pallet jack or similar platform to securely hold a vertical column for supporting a device such as a wine punch down unit.

In compliance with the statute, the invention has been described in language more or less specific as to juice and wine processing equipment. It is to be understood, however, that the invention is not limited to the specific means or features shown or described, since the means and features shown or described comprise preferred ways of putting the invention into effect.

Additionally, while this invention is described in terms of being used for a wine punch down unit, it will be readily apparent to those skilled in the art that the invention can be adapted to other uses in industry and for other forms of juice, vegetable, and food processing, and therefore the invention should not be construed as being limited to wine production equipment. The invention is, therefore, claimed in any of its forms or modifications within the legitimate and valid scope of the appended claims, appropriately interpreted in accordance with the doctrine of equivalents.

What is claimed is:

1. A punch down unit for processing vegetable materials comprising:
a ground engaging platform having a base, a first end and a second end, for placement under a vessel;
a column affixed to the first end of the platform on a substantially vertical axis;
a rigid arm rotatably coupled to the column and vertically positionable along the vertical axis of the column, the rigid arm comprising a body having a first end and a second end, whereby the rigid arm is rotatably positionable on a substantially horizontal plane column;
a vertical shaft carried by said arm, the shaft being extendable in a downward direction and retractable in an upward direction; and
an agitation accessory affixed to the shaft;
whereby the agitator accessory is operational in an upward and downward and side-to-side manner for punching down the vegetable material.

2. The punch down unit of claim 1, wherein the ground engaging platform is a movable pallet truck.

3. The punch down unit of claim 1, wherein the column is affixed to a vertical column adapter mounted on the ground engaging platform, the vertical column adapter comprising:
an essentially pyramid-shaped frame having a top, a base and two sides angled downward and outward from the top to the base;
an aperture sized to the diameter of the column through the top of the frame;
a column mounting bracket on the base, whereby the column extends through the aperture and is secured to the column mounting bracket;
at least one vertical column adapter mounting bracket for securing the vertical column adapter to the ground engaging platform;
whereby the ground engaging platform is adapted to support a punch down unit.

4. The vertical column adapter of claim 1, wherein the at least one mounting bracket is releasably attachable to the ground engaging platform, whereby the ground engaging platform is convertible to a punch down unit, and is convertible back to its original form.

5. The column of claim 1 further comprising a plurality of horizontally opposed apertures and a releasable pin, whereby the pin projects through the aligned apertures providing for the rigid arm to be secured above the pin in a vertical position on the column, while allowing free rotation of the rigid arm about the vertical column.

6. The column of claim 1 including a pneumatic lift for positioning and supporting the rigid arm on the vertical column.

7. The column of claim 1 including a motorized lift for positioning and supporting the rigid arm on the vertical column.

8. The punch down unit of claim 1 further comprising:
at least one rail affixed to the body of the rigid arm and extending along the length of the rigid arm;
an agitator support frame, for supporting the vertical shaft and agitator accessory, having a plurality of rollers rotatably coupled to the agitator support frame;
whereby the vertical shaft and agitator accessory are positionable in unison along the length of the rigid arm.

9. The punch down unit of claim 1, wherein the vertical shaft is a powered ram positioned on a vertical axis, the powered ram comprising a shaft for attachment to an agitation accessory that is extendible in a downward direction and retractable in an upward direction.

10. The punch down unit of claim 1, wherein the vertical shaft is powered by a motor operably coupled to a shaft for attachment to an agitation accessory that is extendible in a downward direction and retractable in an upward direction.

11. The punch down unit of claim 1, wherein the motor operably coupled to the shaft for attachment to the agitation accessory provides rotational force to the shaft, thereby rotating the agitation accessory about the axis of the shaft.

12. The punch down unit of claim 1, wherein the agitation accessory is a paddle having a flat surface oriented on a horizontal plane.

13. A wine punch down unit for use by a winemaker for processing wine, the wine punch down unit comprising:
a ground engaging platform having a base, a first end and a second end, for placement under a vessel containing wine;
a column affixed to the first end of the platform on a vertical axis;
a vertical column adapter comprising:
an essentially pyramid-shaped frame having a top, a base and two sides angled downward and outward from the top to the base;
an aperture sized to the diameter of the column through the top of the frame;
a column mounting bracket on the base, whereby the column extends through the aperture and is secured to the column mounting bracket;
at least one vertical column adapter mounting bracket for securing the vertical column adapter to the ground engaging platform;
whereby the ground engaging platform is adapted to support the column vertically;
a rigid arm rotatably coupled to the column and vertically positionable along the vertical axis of the column, the rigid arm comprising a body having a first end and a second end, whereby the rigid arm is rotatably positionable on a horizontal plane about a pivot point at the first end of the arm and the column;
a vertical shaft affixed to the second end of the arm, the shaft being extendable in a downward direction and retractable in an upward direction; and
an agitation accessory affixed to the shaft,
whereby the agitator accessory is operational in an upward and downward and side-to-side manner for punching down the cap and mixing the cap material with the wine.

14. The wine punch down unit of claim 13, wherein the ground engaging platform is a movable pallet truck.

15. The vertical column adapter of claim 13, wherein the at least one mounting bracket is releasably attachable to the ground engaging platform, whereby the ground engaging platform is convertible to a wine punch down unit, and is convertible back to its original form.

16. The column of claim 13 further comprising a plurality of horizontally opposed apertures and a releasable pin, whereby the pin projects through the aligned apertures providing for the rigid arm to be secured above the pin in a vertical position on the column, while allowing free rotation of the rigid arm about the vertical column.

17. A method for punching down a cap and mixing cap material with wine for processing wine to improve contact between the wine and the cap in order to extract a requisite amount of color and flavor, the method comprising the steps of:
providing a wine punch down unit for use by a winemaker for processing wine, the wine punch down unit comprising:
a ground engaging platform having a base, a first end and a second end, for placement under a vessel containing wine;
a column affixed to the first end of the platform on a vertical axis;
a rigid arm rotatably coupled to the column and vertically positionable along the vertical axis of the column, the rigid arm comprising a body having a first end and a second end, whereby the rigid arm is rotatably positionable on a horizontal plane about a pivot point at the first end of the arm and the column;
a vertical shaft affixed to the second end of the arm, the shaft being extendable in a downward direction and retractable in an upward direction; and
an agitation accessory affixed to the shaft;
positioning the ground engaging platform under the vessel containing wine;
adjusting the rigid arm to a height on the vertical column, whereby the agitator accessory is freely positionable above the fermentation vessel when the vertical shaft is in an upward position;
positioning the rigid arm and the agitator accessory over the vessel containing wine;
extending the vertical shaft and the agitator accessory downward into the vessel;
retracting the vertical shaft and the agitator accessory upward;
repeating the extending and retracting steps, whereby the agitator accessory produces a reciprocating motion in order to punch down the cap, break it up and mix the cap material with the wine;
repositioning the rigid arm and agitator accessory to another position over the vessel; and
repeating the extending, retracting and repositioning steps;
whereby a desired agitation of the cap and wine is achieved.

18. The method of claim 17 further comprising the step of lifting the vessel containing wine off the ground with the ground engaging platform, whereby weight of the filled vessel containing wine acts on the ground engaging platform to stabilize and make rigid the vertical column with respect to the vessel.

19. The method of claim 17 wherein said ground engaging platform is movable across the ground and positionable adjacent said vessel.

20. The method of claim 17 wherein said arm is movable along said column by activation of a pneumatic piston and cylinder to place said arm at the desired height.

21. The method of claim 17 wherein said agitation accessory is movable vertically by a pneumatic piston and cylinder.
